(19) United States
(12) Patent Application Publication
(10) Pub. No.: US 2021/0362420 A1
(43) Pub. Date: Nov. 25, 2021

(54) 3D printer with coater and coater cleaning device and method for cleaning a coater by means of a cleaning device

(71) Applicant: CELO LABS INC., San Francieo, CA (US)

(72) Inventors: Alexander Muller, Diedorf-Vogelsang (DE); Thomas Leinauer, Diedorf (DE); Andreas Muller, Augsburg (DE)

(21) Appl. No.: 16/631,070

(22) PCT Filed: Jun. 6, 2018
(86) PCT No.: PCT/EP2018/064931

§ 371 Date: Jan. 14, 2020

(51) Int. Cl. B29C 64/35; B29C 64/205; B29C 64/386

(52) U.S. Cl. CPC B29C 64/35; B33Y 30/00; B29C 64/386; B29C 64/205

(57) ABSTRACT

Disclosed is a 3D printer 10 having a coater 30 and a coater cleaning device 50. The coater 30 has a container 32 defining an inner cavity 34 for receiving particulate construction material and an output region 36 for outputting the particulate construction material. The coater cleaning device 50 has a cleaning web 52. The coater cleaning device 50 and the coater 30 are configured to move the output region 36 and/or the cleaning web 52 relative to each other for wiping the output region 36 by means of the cleaning web 52.

The present invention relates to a 3D printer with a coater and a coater cleaning device and a method for cleaning a coater of a 3D printer by means of a coater cleaning device. In particular, the present invention relates to a 3D printer with a coater and a coater cleaning device according to the preamble of claim 1. A 3D printer of this type is known, for example, from DE 10 2009 056 687 A1.

Various generative manufacturing processes (and consequently various types of 3D printers, i.e. machines/installations for building up a component in layers) are known.

Some generative manufacturing processes have the following steps in common:

(1) First, particulate material (and particulate construction material, respectively) is applied over the entire surface of/continuously on a construction field, so as to form a layer of unsolidified particulate material.

(2) The applied layer of unsolidified particulate material is selectively solidified in a predetermined partial area (in accordance with the component part to be manufactured), for example by selectively printing a treatment agent, for example a binder (alternatively, for example, by laser sintering).

(3) Steps (1) and (2) are repeated to manufacture a desired component. For this purpose, a construction platform on which the component is built up in layers may, for example, be lowered by respectively one layer thickness before a new layer is applied (alternatively, the coater and the printing device may, for example, be raised by respectively one layer thickness).

(4) Finally, the manufactured component which is formed by the solidified partial areas and is supported and surrounded by loose, unsolidified particulate material may be unpacked.

The construction space in which the component or the components is/are manufactured may, for example, be defined by a so-called construction box (also referred to as “job box”). A construction box of this type may have a circumferential wall structure which is open in an upward direction and extends in a vertical direction (for example formed by four vertical side walls), which may, for example, be formed to be rectangular when viewed from above. A height-adjustable construction platform may be received in the construction box. In this respect, the space above the construction platform and between the vertical circumferential wall structure may for example at least contribute to forming the construction space. An example of such a construction box is, for example, described in DE 10 2009 056 696 A1. However, the construction space may, for example, also be free at the side, i.e. unlimited at the circumference. An upper area of the construction space may, for example, be referred to as a construction field.

A coater (also referred to as a “recoater”) is normally used in the above step (1). Various coaters are known for use in 3D printers, by means of which a particulate construction material may be applied to the construction field (also referred to as construction surface or construction area) in the form of a uniform layer over the entire surface/a continuous layer.

One type of coater uses a roller (short: “roller coater”) in front of which first an amount of particulate construction material is put down and which is then horizontally moved across the construction field to apply the particulate construction material in the form of a uniform layer onto the construction field. In this respect, the roller may be rotated opposite to the moving direction. Coater arrangements with great lengths (and consequently 3D printers with large dimensions) are difficult to realize using a roller coater, amongst others due to a possible deflection of the roller.

Another kind of coater (a so-called “container coater”, for example a “slot coater”) uses a container which defines an inner cavity for receiving particulate construction material, and has an output region (for example an elongated output region), for example comprising an (elongate) output slot, for outputting the particulate construction material. The container coater may, for example, be displaceable across a construction field (for example horizontally, for example transverse to its longitudinal direction), wherein the particulate construction material can be output onto the construction field through the (elongate) output region to thereby apply a uniform/continuous construction material layer over the entire surface of the construction field. The coater may be elongate, for example to span or to cover the length or width of a rectangular construction field. Coater arrangements with great lengths (and consequently 3D printers with large dimensions) can be realized quite well using a container coater.

In the above step (2), a printing device having a print head may for example be used, which applies a treatment agent in a controlled way onto a partial area of the construction material layer applied before. The treatment agent contributes to a (direct and/or later) solidification of the construction material layer in the partial area. For example, the treatment agent may be/contain a binder, for example a binder component of a multicomponent binder.

Alternatively, a laser may, for example, be used in the above step (2) to solidify a partial area of the construction material layer applied previously, in particular by sintering or melting the construction material in the partial area.

The present invention is particularly suitable for a 3D printer with a coater of the second type described above, in short a “container coater”, for example a “slot coater”; however, an application to other types of coater is not excluded.

A coater of this type may, for example, be provided with a stroking/sweeping member by which construction material applied to the construction field is stroked, to compress and/or level the construction material. The stroking/sweeping member may, for example, be arranged adjacent to an/the output slot and/or may delimit the same at least partially, and may, for example, form the so-called output region of the coater together with the output slot.

An example of a “slot coater” is known from DE 10 2009 056 689 A1. See therein, for example, FIGS. 17 to 20.

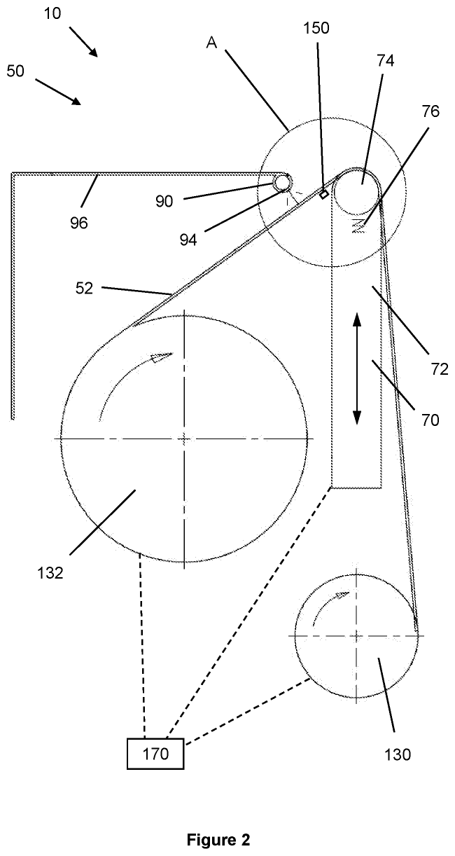

Another example of a “slot coater” is known from WO 2016/030417 A1 and WO 2016/030375 A2 which both describe a so-called bidirectional coater. See for example FIGS. 2, 4, 5, 6, 7 of WO 2016/030417 A1.

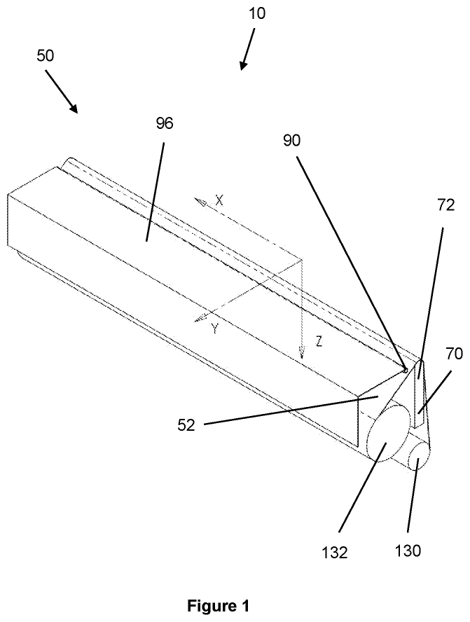

It is, in addition, known to provide a 3D printer with a coater cleaning device by means of which dirt, for example construction material adhering to the lower side of the coater and/or the output region thereof may be removed and/or wiped off, and/or by means of which the output slot of the output region may be wiped off, in order to release obstructions, if necessary. See for example DE 10 2009 056 687 A1; therein, for example, FIGS. 21, 24 and 25, or DE 10 2015 103 726 A1; therein, for example, FIGS. 1 and 2.

The coater cleaning device known from DE 10 2009 056 687 A1 comprises an elongate wiping member in the shape of a brush which is received at least in part in a construction material collection container underneath the coater container. The wiping member is supported rotatably and can be driven rotatably by means of a wiping member driving mechanism. In this respect, cleaning of the coater or rather of the output region thereof, in other words the wiping movement is performed in a direction transverse to the longitudinal direction of the coater.

The elongated wiping member described in DE 10 2009 056 687 A1 may have a disadvantage under certain circumstances, since the wiping member may be deflected, especially if the wiping member is long, and as a result the cleaning quality of the coater and its output region, respectively, may be reduced. A cleaning of the wiping member itself is not described in DE 10 2009 056 687 A1, in which a contamination of the wiping member itself may affect a cleaning result.

The coater cleaning device known from DE 10 2015 103 726 A1 comprises a wiping member (also in the shape of a brush, alternatively a wiper blade or wiper lip) which is moved along a longitudinal direction of the output region for cleaning the output region of the coater, the wiping member being arranged on a revolving carrier structure.

The wiping member described in DE 10 2015 103 726 A1 and in particular its direction of movement relative to the longitudinal direction of the output region can solve the problem of deflection of the wiping member described above, but the movement of the wiping member along the longitudinal direction of the output region can extend the cleaning time. Cleaning of the wiping member itself is suggested in DE 10 2015 103 726 A1 and can be implemented with corresponding additional effort.

It may be considered an object of the present invention to provide a 3D printer and/or a coater cleaning device and a method for cleaning a coater of a 3D printer, by means of which an appropriate coater cleaning can be achieved, in particular in a simple manner and/or in a durable way and/or also for 3D printers with large dimensions and/or in a compact way.

Alternatively or in addition, it may be considered an object of the present invention to provide a 3D printer and/or coater cleaning device and a method for cleaning a coater of a 3D printer, by means of which an efficient (for example fast) coater cleaning can be ensured, in particular also for 3D printers with large dimensions.

Alternatively or in addition, it may be considered as an object of the present invention to provide a 3D printer and/or coater cleaning device and a method for cleaning a coater of a 3D printer, by means of which an improved/good cleaning result can be achieved and/or by means of which a quick/fast cleaning of the coater is possible, in particular also for long coaters and/or for large-dimensioned 3D printers.

For this purpose, the present invention provides a 3D printer according to claim 1, a coater in combination with a coater cleaning device according to claim 17, and a method for cleaning a coater of a 3D printer according to claim 18. Further embodiments of the 3D printer according to the invention are described in the dependent claims.

The inventors of the present invention have found that it is possible to clean the output region/coater appropriately/effectively and efficiently by using a cleaning web. In contrast to the state of the art, which describes the use of a rotating brush or a circulating carrier structure equipped with a cleaning member, the present invention uses a web-shaped cleaning member. Tn this respect, the coater cleaning device and the coater are configured to bring the output region/coater and the cleaning web into contact with each other and to perform a relative movement between the output region/coater and the cleaning web for wiping the output region/coater by means of the cleaning web.

According to various aspects of the present invention, a 3D printer having a coater and a coater cleaning device is provided. The coater has a (for example elongate) container defining an inner cavity for receiving particulate construction material, and an (for example elongate) output region for outputting the particulate construction material (for example onto a construction field). The coater cleaning device comprises a cleaning web. The coater cleaning device and the coater are configured to move the output region and/or the cleaning web relative to each other for wiping the output region by means of the cleaning web (i.e., by using the cleaning web, for example on the cleaning web by moving the coater and/or by respectively with the cleaning web by moving the cleaning web).

For example, the cleaning web may have a thickness less than an extension of the cleaning web in the longitudinal direction and less than an extension of the cleaning web in a width direction (for example, the thickness may be less than or equal to 1/10 of the length and/or width). For example, the cleaning web may have a width which is less than an extension of the cleaning web in a longitudinal direction (for example, the width may be less than or equal to ⅕ or 1/10 of the length). For example, the width of the cleaning web may be greater than or equal to half or entire/full extension of the output region in the longitudinal direction thereof (length of the output region, for example length of the stroking/sweeping surface). For example, the width of the cleaning web may be greater than or equal to 30 cm, for example greater than or equal to 50 cm, for example greater than or equal to 70 cm.

The relative movement is, for example, in the longitudinal direction of the cleaning web and/or in a direction transverse (i.e., at an angle, for example orthogonal) to a longitudinal direction of the coater and/or the output region thereof.

In order to move the output region and/or the cleaning web relative to each other for wiping the output region by means of the cleaning web, the cleaning web may, for example, be stationary, and the output region (e.g. the coater) may be moved (e.g. controlled, e.g. by means of an (electric) drive). Alternatively, to wipe off the output region, the cleaning web may be moved (for example controlled, for example by means of an (electric) drive) and the output region may be stationary. As another alternative, to wipe off the output region, the cleaning web and the output region (e.g. the coater) may be moved (e.g. controlled, e.g. by means of an (electric) drive). I.e., within the meaning of this application, the term “wiping the output region by means of the cleaning web” includes a movement of the cleaning web and/or the output region (e.g. of the coater). Independent thereof, a driving device may be provided which is configured to move the cleaning web to provide a fresh portion thereof before, after or during a cleaning operation, for example in the longitudinal direction thereof.

The inventors of the present invention have found that it may be advantageous for wiping the output region by means of the cleaning web if the coater or its output region is moved, for example transverse (i.e., at an angle, for example orthogonal) to a longitudinal direction of the coater and/or the output region thereof, for example bidirectionally, i.e. back and forth. In this respect, the cleaning web may, for example, be stationary or may be moved as well.

For example, the 3D printer may comprise a controller that is configured to control a/the movement of the coater and/or the cleaning web. For example, the coater cleaning device may comprise an (electric) drive that is configured to move the cleaning web (in a controlled way). For example, the 3D printer may comprise an (electric) drive that is set up to move the coater (in a controlled way).

For wiping the output region and the cleaning web, the output region and the cleaning web are in contact with each other along a (e.g. linear or striped) contact area. For example, the contact area may extend over the entire length of the output region. This allows particularly efficient cleaning.

For example, in a plan view of the coater from above, a longitudinal axis of the output region (for example a longitudinal axis defined by the output region or a stroking/sweeping surface thereof) may be disposed at an angle to a longitudinal axis of the cleaning web (for example of a longitudinal axis defined by the cleaning web) when the coater is in a cleaning position in which it is disposed above the coater cleaning device. For example, the longitudinal axis of the output region may be parallel to or congruent with a longitudinal axis of the container. For example, the (smallest) angle between the longitudinal axis of the output region and the longitudinal axis of the cleaning web may be greater than or equal to 30°, for example greater than or equal to 45°, for example greater than or equal to 60°, for example greater than or equal to 75°, for example greater than or equal to 85°, for example substantially 90°. This allows efficient cleaning to be achieved.

In a plan view, the cleaning web may, for example, at least substantially have the shape of a rectangle. Width can then be taken to mean the dimension of the short/shorter side of the rectangle.

The term “at least substantially” in the sense of this application covers the size or shape mentioned and the tolerances occurring in the art.

The coater cleaning device may, for example, be configured to be stationary, and, for example, parts of the coater cleaning device, e.g. the cleaning web, may be configured to be movable. The coater cleaning device may be configured, for example, to provide a new/fresh (not contaminated) cleaning web portion after/while/before wiping the output region by means of the cleaning web, for example by a controlled movement of the cleaning web.

For example, the cleaning web may be replaceable respectively exchangeable and/or may be configured to be a disposable cleaning web.

By moving the web, for example in the longitudinal direction thereof, a fresh web portion can always be provided, allowing effective cleaning of the coater. By simply replacing the (used) web, it can be ensured that the cleaning member (or a cleaning portion thereof) itself is always clean; costly cleaning of the cleaning member itself in the 3D printer can be saved. The removed cleaning web can either be cleaned externally or be disposed of.

According to various embodiments, the cleaning web may be configured to be finite (i.e. not endless or revolving), with a first end and a second end, where first and second ends are separate from each other, i.e.

are not connected.

The 3D printer may, for example, be configured to perform the generative manufacturing process described above, at least steps (1) to (3).

The 3D printer may, for example, have the same construction space as described above, in which the component/components is/are manufactured and which is at least co-formed by a so-called construction box (also called “job box”). Such a construction box may have a circumferential wall structure extending in a vertical direction, which is open in an upward direction (for example formed by four vertical side walls), which may, for example, be configured to be rectangular in a plan view. A height-adjustable construction platform may be received in the construction box. The space above the construction platform and between the vertical circumferential wall structure may, for example, at least contribute to forming the construction space in this regard. An upper region of the construction space may, for example, be referred to as a construction field.

For example, the 3D printer may comprise a printing device with a print head that is configured to apply a treatment agent onto a partial region of a previously applied construction material layer in a controlled way. In this respect, the treatment agent may contribute to an (immediate and/or later) solidification of the construction material layer in the partial region. For example, the treatment agent may be/contain a binding agent, for example a binder component of a multi-component binder.

The 3D printer may, for example, comprise a stationary filling station into which the coater can be moved, in order to fill the container with (fresh) construction material.

The coater may, for example, be movable into a cleaning position in which it is positioned above the (e.g. stationary) coater cleaning device. The coater cleaning position or coater cleaning device may, for example, be located adjacent to a/the construction field.

The coater (or “recoater”) may be configured as a so-called “container coater”, for example as a “slot coater” (i.e. having a discharge slot).

The coater may, for example, be movable across a/the construction field (e.g. horizontally, e.g. transverse to the longitudinal direction thereof); in this respect, the particulate construction material can be outputted onto the construction field through the (e.g. elongated) output region, in order to thereby apply a uniform, construction material layer onto the entire surface of the construction field/which is continuous. The coater may be elongated, for example to span or cover the length or width of a rectangular construction field. For example, the output region may be formed on a lower portion of the coater and/or may face the construction field.

For example, the container may have an elongated shape in order to span or cover, for example, the entire length or the entire width of a rectangular construction field. The inner cavity of the container may, for example, form a shaft/duct which is, for example, tapered in a downward direction in cross-section (at least in sections) and/or has a funnel shape. The inner cavity for receiving particulate construction material may, for example, lead to the (for example elongate) output region, for example an (elongated) output slot, and may be connected to the same, respectively.

The container may, for example, be supplied with construction material by a charging container travelling along with the same. A distribution device for distributing the construction material may, for example, be received in the optional charging container and/or the container, for example in the form of a distributing worm.

The (e.g. elongated) output region may, for example, comprise an (e.g. elongated) output slot.

For example, the output region may comprise at least one (for example one or two) elongate stroking/sweeping surface which is, for example, arranged adjacent to the output slot. For example, the stroking/sweeping surface may be strip-shaped. For example, the stroking/sweeping surface may be oriented downwards and/or may face the construction field. In the case of two stroking/sweeping surfaces, they may be located on two opposite sides of the output slot in the transverse direction thereof to provide a bidirectional coater.

The at least one stroking/sweeping surface is configured to stroke construction material output from the container, for example to thereby level and/or compress the output construction material. Due to the relative movement between the output region and the cleaning web, the at least one stroking/sweeping surface can be wiped for a cleaning thereof by means of the cleaning web. Thereby, for example, dirt adhering to the stroking/sweeping surface may be removed, such as components of a treatment agent and/or components of a construction material.

For example, the stroking/sweeping surface may be formed by a stroking/sweeping element, which may, for example, be provided in the form of a so-called stroking/sweeping strip and/or stroking/sweeping blade, for example by a downwardly directed portion of the stroking/sweeping element, which may, for example, project/protrude downwards, for example in steps.

For example, the (respective) stroking/sweeping surface may be configured to be planar. The one or more stroking/sweeping surfaces or stroking/sweeping elements may, for example, be arranged adjacent to an/the output slot and/or may limit the same, for example in a transverse direction. For example, an/the output slot may be arranged in a transverse direction between two stroking/sweeping surfaces or stroking/sweeping elements. The coater can thus be configured or operated as a bidirectional coater, with the rear stroking/sweeping surface in the direction of travel being respectively active. For example, at least the respectively active stroking/sweeping surface (e.g. the entire coater) can be tilted in this regard, in order to set a so-called setting angle of the stroking/sweeping surface with respect to the construction field and thus a degree of compression of the particulate material.

The one or more stroking/sweeping elements may, for example, be fixed to the container of the coater. The one or more stroking/sweeping elements may, for example, be fixed to and/or suspended from a carrier structure of the coater, for example together with an optional closing device for selectively closing the output slot.

Said carrier structure may, for example, extend transverse to the direction of movement of the coater and/or in a longitudinal direction of the coater. The container may also be fixed to the carrier structure, for example separately from the at least one stroking/sweeping element and/or the optional closing device.

For example, the (elongated) output region and/or the (elongated) output slot and/or one or more (elongated) stroking/sweeping surfaces may be directed downward, for example towards the construction field. The (elongated) output region and/or the (elongate) output slot and/or the one or more (elongated) stroking/sweeping surfaces may have a first extension in the longitudinal direction and a second extension in the transverse direction, the first extension being greater than the second extension, for example at least by a factor of 2, 3, 4, 5, 6, 7, 8, 9, 10, 11, 12, 13, 14, 15, 16, 17, 18, 19, 20 or greater. For example, the (elongated) output region and/or the (elongate) output slot and/or the respective (elongated) stroking/sweeping surface may have at least substantially a rectangular shape and/or stripe shape in plan view.

According to various embodiments, in a cross-sectional view (for example, a cross-sectional view orthogonal to a longitudinal axis of the stroking/sweeping surface) of the coater, the cleaning web may approach from below the at least one stroking/sweeping surface (for example, a/the contact area where the cleaning web and the stroking/sweeping surface are in contact) such that the longitudinal axis of the (approaching) cleaning web forms an acute (entrance) angle with the stroking/sweeping surface to be cleaned when the coater is in a cleaning position.

For example, in a cross-sectional view (for example, a cross-sectional view orthogonal to a longitudinal axis of the stroking/sweeping surface) of the coater, the cleaning web may move downward from the at least one stroking/sweeping surface (for example, from a/the contact area where the cleaning web and the stroking/sweeping surface are in contact) so that the longitudinal axis of the cleaning web (moving away) is arranged at an acute (exit) angle to the at least one stroking/sweeping surface when the coater is in a cleaning position.

The inventors of the present invention have found out that the coater cleaning device may be configured particularly compact by approaching or moving away the cleaning web at an angle.

According to various embodiments, the cleaning web may be formed (i.e., may comprise or consist of) of an absorbent material configured to absorb a liquid cleaning agent. The cleaning web may, for example, be made of an absorbent (e.g. sheet-like) textile such as an absorbent fabric or an absorbent nonwoven or an absorbent cloth. The cleaning web may, for example, have a single-layer or a multi-layer (e.g. two-layer) structure. For example, in a two-layer structure, an absorbent layer (first layer) may be arranged on a tensile-stable layer (second layer); in this respect, for example, both layers may also be absorbent and the absorbency of the first layer may be greater than the absorbency of the second layer.

This allows the cleaning web to be infiltrated with cleaning agent, i.e. a liquid cleaning agent (e.g. solvent) to be absorbed into the cleaning web and stored there for later/subsequent wiping of the output region and/or stroking/sweeping surface, for example with a defined and/or set amount, so that the output region and/or stroking/sweeping surface can be wiped off with a cleaning web moistened with cleaning agent, allowing even solid or “persistent” adhesions/deposits to be removed efficiently.

For example, when applying moist construction material/particulate material, for example sand premixed with a liquid binder component (e.g. a liquid activator), there may be deposits on the coater that are difficult to remove. For example, these deposits may occur on the so-called scraper blade, i.e. on the stroking/sweeping element. Such impurities may disrupt/negatively influence the quality of the coating process and lead to the discontinuation of the manufacturing process. The impurities may increase with the coating length and the number of layers. Especially with large 3D printers and/or in automatic mode, where many construction jobs are repeated without the intervention of an operator, this may lead to problems and restrictions in the construction quality and even to job interruptions. Various cleaning units for powder application devices are known today; see the prior art documents discussed above. With such devices, coarse adhesions can be safely removed; however, it is more difficult to clean solid or “persistent” adhesions which form in the course of the construction job as a result of chemical reactions, for example. Such impurities may, for example, be attributed to so-called evaporation or crystallization of the activator, an unintentional reaction of the activator with vapors of a binder component already printed on, adhesion of a swirled, previously printed binder component with the activator to the coater, etc.

Solid or “persistent” impurities may be removed, for example, by means of a suitable solvent, which is transported to the output region to be cleaned by means of the absorbent cleaning web. In addition, the dissolved impurities, i.e. the solvent and the dirt dissolved therein, can be reliably absorbed in the absorbent cleaning web, so that the dirt can be reliably removed.

According to various embodiments, the cleaning web may have such an extension in the width direction that in a plan view of the coater from above and/or in a side view thereof, the two longitudinal ends of the at least one stroking/sweeping surface do not extend beyond the cleaning web when the coater is in a cleaning position.

This allows the contact area where the cleaning web and the stroking/sweeping surface are in contact to extend over the entire length of the stroking/sweeping surface and allows the stroking/sweeping surface to be cleaned quickly.

According to various embodiments, the coater cleaning device may comprise a pressing device which is configured to press the cleaning web against the output region (for example the stroking/sweeping surface) (for example in the above-mentioned contact area) when the coater is in a cleaning position. This can result in a particularly effective cleaning result.

According to various embodiments, the pressing device may have a support structure over which the cleaning web extends. The support structure may, for example, be height-adjustable (in a vertical direction), for example by means of an (electric) drive and/or in a controlled way.

The support structure may, for example, be arranged vertically under the coater when the coater is in a cleaning position. For example, the cleaning web may be located between the output region (e.g. the stroking/sweeping surface) and the support structure when the coater is in a cleaning position.

According to various embodiments, the support structure may comprise a sliding element on which the cleaning web is supported/abuts. The sliding element may be made of an elastic material, i.e. the sliding element may be made of or provided, for example coated, with an elastic material. For example, a rubberized sliding element may be used. Alternatively or additionally, the sliding element may be subjected to a spring force which presses the sliding element against the cleaning web and subsequently the cleaning web against the output region when the coater is in a cleaning position. The support structure may, for example, comprise one or more springs to apply a spring force to the sliding element. For example, the one or more springs may be located under the sliding element. In a cross-sectional view, the sliding element may, for example, be configured at least in sections and/or substantially to be round/spherical.

For example, the support structure and/or the sliding element may be elongated. For example, the length of the support structure and/or the sliding element may be greater than or equal to the length of the output region (e.g. the stroking/sweeping surface).

If the support structure is height-adjustable and/or the sliding element is made of an elastic material and/or the sliding element is subjected to a spring force, a force can be defined with which the cleaning web is pressed against the output region (e.g. the stroking/sweeping area). This can improve the cleaning effect.

According to various embodiments, the coater cleaning device may have a cleaning agent supply device which is configured to supply a (e.g. liquid) cleaning agent to the cleaning web (e.g. in a controlled way).

For example, the cleaning agent supply device may be arranged to moisten and/or infiltrate with cleaning agent a portion of the cleaning web located in front of or in a contact area as seen in the longitudinal direction of the web where the output region and the cleaning web contact each other for wiping the output region by means of the cleaning web. The portion of the cleaning web (to be moistened) may, for example, extend over substantially the entire width of the cleaning web and/or may have an extension in the width direction of the web greater than or equal to the length of the contact area.

The cleaning agent supply device may, for example, be integrated into the sliding element. For this purpose, the sliding element may be a (e.g. elastic) line (e.g. an (elastic) hose or an (elastic) pipe) comprising through-holes through which the cleaning agent can be fed to the cleaning web. For example, the through-holes may be located on a portion of the sliding element facing the output region (e.g. the stroking/sweeping surface). For example, the through-holes may be arranged at intervals along a/the longitudinal direction of the sliding element (for example along a/the full length of the sliding element) and/or cover substantially the full width of the cleaning web.

Alternatively or additionally, the cleaning agent supply device may be located, as seen in a web longitudinal direction, in front of a/the contact area where the output region (e.g. the stroking/sweeping surface) and the cleaning web contact (e.g. touch) each other for wiping the output region (e.g. the stroking/sweeping surface) by means of the cleaning web. For this purpose, for example, a cleaning agent supply line may be arranged in front of the contact area and adjacent to the cleaning web, seen in the longitudinal direction of the web. For example, the cleaning agent supply line may comprise spraying nozzles configured to supply the cleaning agent to the cleaning web. For example, the spraying nozzles may be arranged along a/the longitudinal direction of the cleaning agent supply line (for example at regular intervals, for example along a/the full length of the cleaning agent supply line) and/or cover substantially the full width of the cleaning web.

According to various embodiments, the coater cleaning device may comprise a rotatable roll-up element, e.g. a rotatable roll-up roller, onto which the cleaning web (e.g. a dirty/used section thereof) can be rolled/wound up, the roll-up element being optionally replaceable for removing the dirty cleaning web from the coater cleaning device and/or optionally being a (e.g. electrically) driven roll-up element.

The cleaning web may, for example, be fixed to the roll-up element (for example with the first end thereof). For example, the roll-up element may be driven by means of a drive by the/a controller to successively roll-up the cleaning web onto it. For example, the roll-up element may be positioned, as seen in the longitudinal direction of the web and/or in a horizontal direction behind the contact area. For example, the roll-up element may be located in a vertical direction below the contact area and/or the pressing device.

According to various embodiments, the coater cleaning device may comprise a rotatable unrolling/roll-off element, e.g. a rotatable unrolling roller, from which the cleaning web (e.g. a fresh portion thereof) can be unrolled/unwound, wherein the unrolling element is optionally exchangeable for refilling another unrolling element, onto which a fresh cleaning web is wound, and/or optionally is an (e.g. electrically) driven unrolling element.

The second end of the cleaning web may, for example, be attached to the unrolling element and may be covered by a winding of the cleaning web. In the course of time, the cleaning web is unwound successively from the unrolling element so that a new/fresh (not dirty respectively clean) piece of cleaning web is provided for subsequent wiping. For example, the unrolling element can be positioned in front of the contact area as seen in the longitudinal direction of the web and/or in the horizontal direction. For example, the unrolling element may be located in a vertical direction below the contact area.

For example, the roll-up element and the unrolling element may be configured to move the cleaning web during the wiping of the output region, for example bidirectionally. In this case, both elements can be driven elements. Otherwise, it may be sufficient, for example, to drive only the roll-up roller.

According to various embodiments, the coater cleaning device may comprise a sensor configured to determine an amount of cleaning agent absorbed into the cleaning web. For example, the sensor may be located in front of a/the contact area and following/behind the cleaning agent supply device when viewed in the longitudinal direction of the web. Alternatively or additionally, the/a sensor may be integrated into the sliding element, for example. According to various embodiments, the coater cleaning device may comprise a controller which is configured to control, for example variably adjust, for example depending on a degree of contamination of the output region and/or a period of time elapsed since the last cleaning and/or a construction material used in 3D printing and/or a binder component used in 3D printing and/or a quantity of cleaning agent absorbed by the cleaning web,

the relative movement between the output region and the cleaning web, “movement pattern”, and/or the quantity and/or type of cleaning agent supplied to the cleaning web by the cleaning agent supply device, and/or

a height adjustment of the support structure and/or the spring force and/or a pressing force of the pressing device, and/or

a drive of the roll-up element and/or a drive of the unrolling element, and/or a drive of the cleaning web and/or a drive of the coater.

For example, a “movement pattern” may include a movement of the coater (e.g., a movement (e.g., movement forth/to and back/from) in a direction transverse (e.g., orthogonal) to its longitudinal axis and/or the longitudinal axis of the output region and/or the stroking/sweeping surface). For example, the movement of the coater may be continuous or intermittent. For example, another “movement pattern” may include a movement at a different speed and/or a different duration of movement, or (for example, in addition to the movement of the coater) may include a movement of the cleaning web, for example a back and forth movement in the longitudinal direction of the web.

For example, the cleaning agent supply device and/or the sensor may be connected to the controller. For example, the controller may be configured to control the cleaning agent supply device according to a signal from the sensor. For example, if it is determined by means of the sensor that a/the quantity of cleaning agent is low, the controller may control the cleaning agent supply device to supply/output more cleaning agent.

The coater cleaning device may comprise a drive device configured to move the cleaning web in the longitudinal direction thereof, for example past the output region and/or for example to provide a fresh and/or moistened and/or infiltrated cleaning web portion for wiping the output region by means of the cleaning web.

The coater cleaning device may, for example, include a covering device for covering a (for example not contaminated) portion of the cleaning web. For example, the covering device may be arranged to cover the unrolling element (upwards) and/or may be arranged above the unrolling element. For example, the cleaning agent supply device may be located/attached to the covering device. For example, the covering device may have a longitudinal extension equal to or greater than the width of the cleaning web.

According to another aspect of the invention, a coater and a coater cleaning device are provided, wherein the coater cleaning device comprises a cleaning web and the coater cleaning device and the coater are configured to perform, in a state where the coater is contacted by a portion of the cleaning web, a relative movement between the coater and the cleaning web for wiping the coater by means of the cleaning web. In this respect, the coater and the coater cleaning device may be configured as described above.

According to various aspects of the present invention, a method is provided for cleaning a coater of a 3D printer using a coater cleaning device, wherein the coater cleaning device has a cleaning web which for example is made of an absorbent material and/or is formed to be finite and/or exchangeable and/or is formed as a disposable web, comprising:

contacting the coater with the cleaning web and

performing a relative movement between the coater and the cleaning web for wiping the coater by means of the cleaning web, for example in a moistened state of the cleaning web.

In this respect, the coater and the coater cleaning device may be configured as described above. This means, for example, that the coater may comprise a container which defines an inner cavity for receiving particulate construction material, and an output region for outputting the particulate construction material, wherein the output region is wiped by means of the cleaning web by relatively moving the output region and the cleaning web.

The method may, for example, further comprise moving the coater into a coater cleaning position in which the coater is arranged above the coater cleaning device, and/or supplying a cleaning agent to the cleaning web using a/the cleaning agent supply device, and/or infiltrating the cleaning web with a liquid cleaning agent using a/the cleaning agent supply device, and/or replacing the (e.g. contaminated) cleaning web with another (e.g. not contaminated or fresh) cleaning web, for example after the cleaning web has been contaminated/used or in adaptation to a construction material and/or binder system and/or cleaning agent used.

In the method, for example, the step of contacting the output region with the cleaning web may include moving the coater to the coater cleaning device or into its cleaning position and/or height-adjusting a support structure on which the cleaning web is supported, for example towards the output region, for example in a controlled way and/or by means of a drive of the support structure.

In the method, for example, the step of exchanging the cleaning web may comprise replacing an unrolling element with another unrolling element onto which another cleaning web is wound, and replacing the roll-up element with another roll-up element onto which the other cleaning web can be wound.

In addition, the information provided above as to the 3D printer analogously applies to the method.

Furthermore, the following applies to both the method and the 3D printer:

Particulate construction material within the meaning of this application may be understood as a construction material comprising at least one kind of particulate material (for example (grains of) sand, for example foundry sand, and/or metal particles and/or particles of synthetic material). Different types of particulate material may be included in the construction material as well, such as a mixture of new sand and recycled sand or a mixture of fine sand and coarse sand or a mixture of two different types of sand. Moreover, the construction material may comprise at least one liquid component, for example a binder component, for example an activator, and/or one or more solid and/or liquid additives. In case that the construction material contains a binder component, another binder component, such as furan resin, may selectively be printed onto a previously applied construction material layer by means of a printing device, so as to solidify this layer in a predetermined area. Depending on the component to be manufactured, for example a casting mold or a foundry core, a construction material composition specifically prepared for this purpose may be used. In this respect, the construction material composition may be defined by the number of components used as well as by the respective type and the respective share of components contained in the construction material (mixture). In this respect, the trickle or flow behavior of the construction material as well as reactivity or the risk of chemically induced adhesions to the coater may vary considerably depending on the composition of the construction material. Correspondingly, the temporal occurrence and/or the degree of contamination and thus a necessary cleaning may vary according to the composition of the construction material used.

According to various embodiments, the coater may, for example, be provided with a vibration device by means of which the particulate material received in the inner cavity may be vibrated to influence, for example to support, the flow or trickle behavior of the particulate construction material or the discharge of the particulate construction material from the output region. A vibration device of this type may, for example, be formed by a shaking device by means of which at least a wall portion of the container is vibrated or exposed to a shaking motion to influence the discharge of the particulate construction material. According to various embodiments, also a particulate construction material having a poor trickle or flow behavior may be vibrated appropriately using a vibration device, and/or a wall portion of a container receiving the construction material may be exposed to an appropriate shaking motion using a shaking device.

Exemplary but non-limiting embodiments of the present invention are shown in the Figures and are hereinafter described in detail.

FIG. 1 shows a perspective view of a coater cleaning device of a 3D printer according to an embodiment of the present invention.

FIG. 2 shows a cross-sectional view of the coater cleaning device of a 3D printer of FIG. 1.

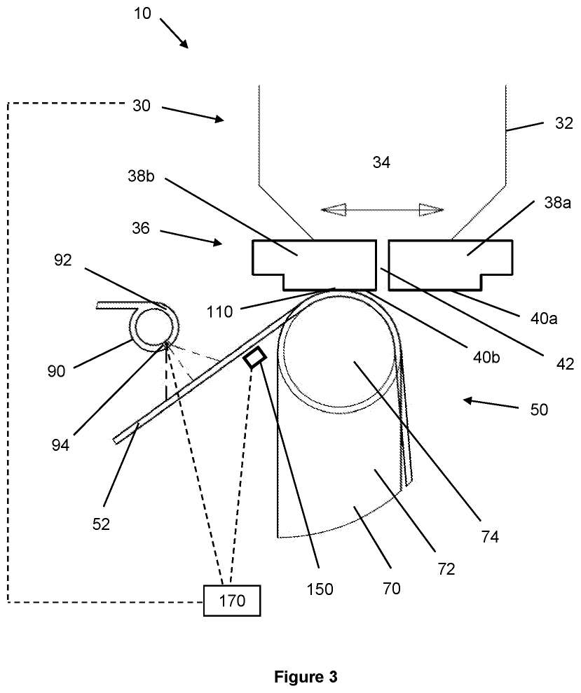

FIG. 3 shows an enlarged view of area A of FIG. 2, wherein a coater is additionally shown (also in cross-section), and wherein the spring shown in FIG. 2 has been omitted.

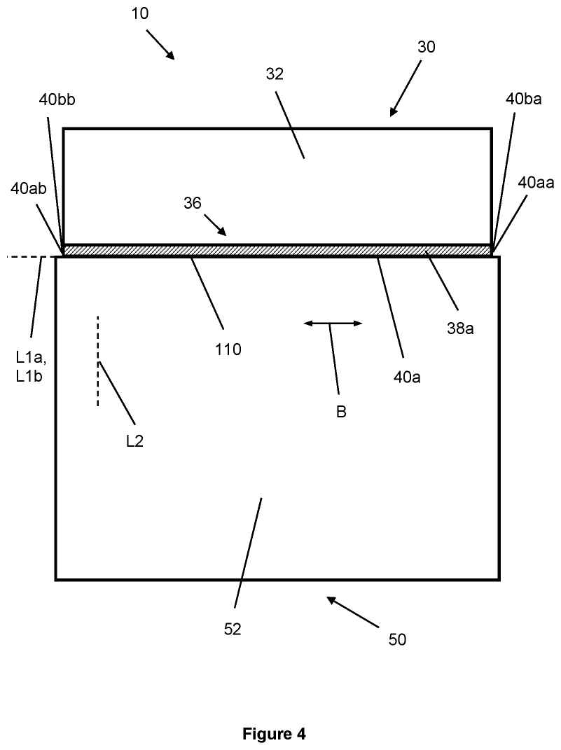

FIG. 4 shows a side view of a coater and a coater cleaning device of a 3D printer according to an embodiment of the present invention.

In the following detailed description, reference is made to the enclosed Figures which are incorporated therein and in which specific embodiments are shown by way of illustration, according to which the invention can be performed. In this respect, the terms “up”, “down”, “front”, “rear”, etc. are used with reference to the orientation in the described Figure(s). As components of embodiments may be positioned in a number of different orientations, the terminology indicating the different directions serves for illustration and shall not be restrictive in any way.

It shall be understood that other embodiments may be used and structural or logical changes may be made without deviating from the scope of protection of this invention. It goes without saying that the features of the various exemplary embodiments described herein may be combined unless specified otherwise. Thus, the following detailed description should not be understood in a restrictive sense and the scope of protection of this invention shall be defined by the attached claims.

In this description, terms such as “connected”, “attached” and “coupled” may be used to describe both a direct and indirect connection, a direct or indirect attachment and a direct or indirect coupling.

In the Figures, identical or similar elements are provided with identical reference numbers where appropriate.

FIG. 1 shows a simplified perspective view of a coater cleaning device 50 of a 3D printer 10, wherein in FIG. 1 parts of the coater cleaning device 50 have been omitted for reasons of clarity (such as the sensor 150 and the controller 170). FIG. 2 shows a simplified cross-sectional view of the coater cleaning device 50 of FIG. 1. FIG. 3 shows an enlarged view of area A of FIG. 2, with the spring 76 having been omitted and an additional coater 30 of the 3D printer 10 being shown. FIG. 4 shows a simplified side view of the coater cleaning device 50 and coater 30 of the 3D printer 10, parts of the coater cleaning device 50 having been omitted in FIG. 4 for reasons of clarity.

As shown in FIGS. 3 and 4, the 3D printer 10 comprises a coater 30 and a coater cleaning device 50. The coater 30 comprises a container 32 defining an inner cavity 34 for receiving particulate construction material and an output region 36 for outputting the particulate construction material. The coater cleaning device 50 comprises a cleaning web 52. The coater cleaning device 50 and the coater 30 are configured to contact the output region 36 and the cleaning web 52 with each other and to perform a relative movement between the output region 36 and the cleaning web 52 such that the output region 36 is wiped by means of the cleaning web 52.

For example, the coater 30 may be elongated and may define a longitudinal axis (not shown) extending in FIG. 3 orthogonal to the sheet and extending in FIG. 4 parallel to the axis L1a and L1b, respectively, (in FIG. 1, this coater longitudinal axis would extend in the X direction). The output region 36 may, for example, be elongated and comprise an (elongate) output slot 42 for outputting the particulate construction material.

The output region 36 may, in addition, comprise for example two (elongated) stroking/sweeping elements 38a, 38b which are arranged adjacent to the output slot 42 and delimit it laterally. The stroking/sweeping elements may, for example, each define an (elongated) stroking/sweeping surface 40a, 40b for stroking/sweeping (for example levelling and/or compressing) the output construction material. The two stroking/sweeping surfaces 40a, 40b may, for example, each define a longitudinal axis L1a, L1b and two longitudinal ends 40aa, 40ab, 40ba, 40bb, wherein the longitudinal axes L1a, L1b of the stroking/sweeping surfaces 40a, 40b, are, for example, parallel. The relative movement between the output region 36 and the cleaning web 52 allows, for example, the two stroking/sweeping surfaces 40a, 40b to be wiped for cleaning by means of the cleaning web 52. To generate the relative movement between the output region 36 and the cleaning web 52, the coater 30 can be moved, for example, by means of an electric motor (not shown), for example, in the direction of and/or along the double arrow shown in

FIG. 3. In this respect, the coater may, for example, be moved in a direction transverse to its longitudinal axis, for example back and forth, for example in such a way that the entire output region is moved over the contacted web section (for example several times) and is subsequently cleaned.

The cleaning web 52 may, for example, be formed to be finite (see FIG. 2), with a first end and a second end. For example, the cleaning web 52 may define a cleaning web longitudinal axis L2 and/or a cleaning web width direction B. The width direction B may, for example, be at least substantially orthogonal to the longitudinal axis L2. The cleaning web 52 may, for example, comprise or be made of an absorbent material, the absorbent material being configured to absorb a liquid cleaning agent. For example, the width of the cleaning web 52 (i.e., the extension of the cleaning web 52 in the width direction B) may be equal to or greater than the length of the output region 36 (i.e., the extension of the output region 36 in its longitudinal direction) and/or the length of the stroking/sweeping surfaces 40a, 40b (i.e., the extension of the stroking/sweeping surfaces 40a, 40b in the direction of the longitudinal axis thereof Lia, Lib) (see FIG. 4).

For example, the coater 30 may be moved into a cleaning position in which it is arranged above the coater cleaning device 50 (see FIG. 3). When the coater 30 is in its cleaning position, the (parallel) longitudinal axes L1a, L1b of the stroking/sweeping surfaces 40a, 40b may be arranged at an angle to the longitudinal axis L2 of the cleaning web 52 in a plan view of the coater 30 from above, for example. The angle between L1a and L1b, respectively, and L2 may, for example, substantially be 90° (see in this regard also FIGS. 3 and 4). In a cross-sectional view of the coater 30, when the coater 30 is in its cleaning position, the cleaning web 52 may approach one of the stroking/sweeping surfaces 40a, 40b from below, for example, so that the longitudinal axis L2 of the cleaning web 52 is arranged at an angle to the stroking/sweeping surfaces 40a, 40b (see FIG. 3). When the coater 30 is in its cleaning position, the cleaning web 52 may have such an extension in the width direction B that in a plan view of the coater 30 from above the longitudinal ends 40aa, 40ab, 40ba, 40bb of the stroking/sweeping surfaces 40a, 40b do not extend beyond the cleaning web 52 (also see FIG. 4 in this regard).

The coater cleaning device 50 may, for example, comprise a pressing device 70 which is configured to press the cleaning web 52 against the output region 36 and/or the stroking/sweeping surfaces 40a, 40b, when the coater 30 is in its cleaning position (see FIG. 3). For example, the pressing device 70 may comprise a support structure 72 on which the cleaning web 52 is supported and which is configured to press the cleaning web 52 against the output region 36 and/or the stroking/sweeping surfaces 40a, 40b, when the coater 30 is in its cleaning position. The support structure 72 may, for example, have a sliding element 74 on which the cleaning web 52 is supported/abuts. For example, the sliding element 74 and/or the support structure 72 may be elongated and may define a longitudinal axis (not shown). A length of the sliding member 74 (i.e., an extension of the sliding member 74 along its longitudinal axis) and/or the support structure 72 (i.e., an extension of the support structure 72 along its longitudinal axis) may be greater than or equal to a length of the output region 36 and/or the stroking/sweeping surfaces 40a, 40b. The sliding element 74 may, for example, be made of an elastic material. Alternatively or in addition, the sliding element 74 may be loaded with a spring force which presses the sliding element 74 against the cleaning web 52 and subsequently presses the cleaning web 52 against the output region 36, when the coater 30 is in its cleaning position. In order to apply a spring force to the sliding element 74, the support structure 72 may, for example, comprise springs 76 which are arranged below the sliding element 74. The springs 76 may, for example, be coil springs, as shown in FIG. 2.

The support structure 72 may, for example, be height-adjustable, for example by means of an electric motor (not shown), for example in the direction of and/or along the double arrow shown in FIG. 2. By means of the height adjustment, the cleaning web 52 may be brought into and out of contact with the output region 36 and the stroking/sweeping surfaces 40a, 40b, respectively. For example, the support structure 72 and thus also the cleaning web 52 supported thereon may be in a lowered position when the coater 30 is not in its cleaning position. After the coater 30 having been moved into its cleaning position, the support structure 72 can then be adjusted in height so that the cleaning web 52 is contacted with the output region 36 and the stroking/sweeping surfaces 40a, 40b, respectively.

As shown in FIGS. 1 and 2, the coater cleaning device 50 may, for example, comprise a rotatable roll-up roller 130 onto which the cleaning web 52 can be rolled up. Furthermore, the coater cleaning device 50 may, for example, comprise a rotatable unrolling/roll-off roller 132, from which the cleaning web 52 can be unrolled/rolled off. The roll-up roller 130 and/or the unrolling roller 132 may be exchangeable and/or may be driven, for example, by means of an electric motor (not shown). For example, the roll-up roller 130 and/or the unrolling roller 132 may respectively define a roller longitudinal axis (not shown). For example, a length of the roll-up roller 130 (i.e., an extension of the roll-up roller 130 in the direction of its roller longitudinal axis) and/or of the unrolling roller 132 (i.e., an extension of the unrolling roller 132 in the direction of its roller longitudinal axis) may be greater than or equal to a width of the cleaning web 52.

The above pressure device may be provided between the roll-up roller and the unrolling roller as seen in the longitudinal direction of the web and/or in a horizontal direction.

As described, a fresh cleaning web 52 may be provided, for example, on the unrolling roller 132. Alternatively, for example, a fresh cleaning web 52 may be folded several times, in which case the unrolling roller 132 can be dispensed with.

The first end of the cleaning web 52 may, for example, be attached to the roll-up roller 130, so that the cleaning web 52 can be wound onto the roll-up roller 130 by a rotational movement of the roll-up roller 130.

The cleaning web 52 may, for example, extend from the unrolling roller 132 via the support structure 72 (and/or the sliding element 74 thereof) to the roll-up roller 130 (see FIG. 2). The cleaning web can be unwound from the unrolling roller 132 and wound onto the roll-up roller 130 by a rotary movement of the roll-up roller 130. This allows, for example, a fresh cleaning web 52 portion to be provided. For example, after wiping the output region 36 and/or the stroking/sweeping surface 40a, 40b with the cleaning web 52, the portion of the cleaning web 52 with which the output region 36 and/or the stroking/sweeping surface 40a, 40b was wiped may be dirty. By rotating the roll-up roller 130, a fresh, unsoiled cleaning web 52 portion can simply be provided for further/following/later cleaning.

It may be sufficient to drive only the roll-up roller 130 to move the web. In this respect, the unrolling roller 132 may, for example, be configured to provide or to have an unrolling resistance, so that the cleaning web 52 is held in tension. In addition or alternatively, a web tensioning element may also be provided.

The coater cleaning device 50 may, for example, comprise a cleaning agent supply device 90 configured to supply the cleaning web 52 with a cleaning agent. For example, the cleaning agent supply device 90 may be integrated into the sliding element 74 (not shown in the Figures) and/or may be disposed, as seen in the longitudinal direction of the web (i.e., in the direction of the longitudinal axis L2 of the cleaning web 52), in front of a contact region 110 where the output region 36 and the cleaning web 52 contact each other for wiping the output region 36 by means of the cleaning web 52 (see FIGS. 2 and 3). For example, the contact region 110 may extend along the entire length of the output region 36 and the stroking/sweeping surfaces 40a, 40b, respectively (see FIG. 4). For example, the cleaning agent supply device 90 may be elongated. For example, the cleaning agent supply device 90 may comprise an elongated cleaning agent supply line 92 and spraying nozzles 94 arranged thereon, by means of which a/the liquid cleaning agent is sprayed onto the cleaning web 52. A length of the cleaning agent supply device 90 and of its cleaning agent supply line 92, respectively, may, for example, be greater than or equal to a width of the cleaning web 52. The spraying nozzles 94 may, for example, be arranged at regular intervals along the entire length of the cleaning agent supply line 92, as seen in a longitudinal direction of the cleaning agent supply line 92.

For example, the coater cleaning device 50 may comprise a covering device 96 by means of which a fresh, unsoiled portion of the cleaning web 52 may be screened/covered, making contamination at least more difficult. For example, the covering device 96 may be arranged above the unrolling roller 132. As shown in FIGS. 1 to 3, the cleaning agent supply device 90 may, for example, be arranged on the covering device 96. For example, the cleaning agent supply line 92 may be arranged on/fixed to the covering device 96, wherein the spraying nozzles 94 can be arranged as described above.

For example, the coater cleaning device 50 may comprise a sensor 150 to determine the amount of cleaning agent absorbed by the cleaning web 52. For example, the sensor may be located in front of the contact region 110 and behind the cleaning agent supply device 90 and adjacent to the cleaning web 52 (see FIGS. 2 and 3), as viewed in the longitudinal direction of the web. Alternatively or in addition, the sensor 150 may, for example, be integrated in the sliding element 54 (not shown), for example, when the cleaning agent supply device 90 is integrated in the sliding element 54.

The coater cleaning device 50 may, for example, comprise a controller 170 which is configured to variably adjust the relative movement between the output region 36 and the stroking/sweeping surfaces 40a, 40b, respectively, and the cleaning web 52, so-called “movement patterns”, and/or the amount and/or type of cleaning agent of the cleaning device, for example depending on a degree of contamination of the output region 36 (and stroking/sweeping surfaces 40a, 40b, respectively) and/or a construction material used in 3D printing and/or a binder component used in 3D printing.

Movement patterns are understood as being the movements of the coater 30 and/or the cleaning web 52 during the cleaning process.

For example, the controller 170 may be connected to a/the drive of the coater 30, a/the drive of the roll-up roller 130, a/the drive of the unrolling roller 132, a/the drive of the support structure 72, the spraying nozzles 94 and/or the sensor 170. The controller 170 can control the spraying nozzles 94 so that a defined amount and/or a desired type of cleaning agent is dispensed.

The controller 170 can control the drive of the roll-up roller 130 and/or the drive of the unrolling roller 132 to provide a fresh cleaning web portion and/or perform a desired movement pattern of the cleaning web 52 during wiping of the output region 36 with the cleaning web 52.

The controller 170 can control the drive of the coater 30 so that a desired movement pattern of the coater 30 is performed while wiping the output region 36 and the stroking/sweeping surfaces 40a, 40b, respectively, with the cleaning web 52.

A corresponding method for cleaning a coater 30 of a 3D printer 10 with a coater cleaning device 50, wherein the coater cleaning device 50 comprises a cleaning web 52, which for example is made of an absorbent material and/or is formed to be finite and/or is configured as a disposable web and/or is formed to be exchangeable, may comprise:

contacting the coater 30 with the cleaning web 52 (as indicated in FIG. 3), and carrying out a relative movement between the coater 30 and the cleaning web 52 (as also indicated in FIG. 3) for wiping the coater 30 by means of the cleaning web 52, for example in a moistened state of the cleaning web and/or by moving the coater, for example in a direction transverse to the longitudinal direction thereof. The previous description of specific exemplary embodiments of this invention has been presented for the purpose of illustration and description. It is not intended to be exhaustive or to limit the invention to the exact forms disclosed, and it is to be understood that various modifications and variations are possible in the light of the teaching disclosed above. The exemplary embodiments have been chosen and described to explain certain principles of the invention and their practical application, to hereby enable those skilled in the art to manufacture and use various exemplary embodiments of this invention as well as various alternatives and modifications thereof. It is intended that the scope of protection of the invention shall be defined by the attached claims and their equivalents.

1. A 3D printer (10) having a coater (30) and a coater cleaning device (50),
the coater (30) comprising a container (32) defining an inner cavity (34) for receiving particulate construction material and an output region (36) for outputting the particulate construction material,
characterized in that
the coater cleaning device (50) comprises a cleaning web (52), and
the coater cleaning device (50) and the coater (30) are configured to move the output region (36) and/or the cleaning web (52) relative to each other for wiping the output region (36) by means of the cleaning web (52).

2. The 3D printer (10) according to claim 1, wherein the cleaning web (52) is configured to be finite, having a first end and a second end, and/or as a disposable cleaning web and/or to be exchangeable.

3. The 3D printer (10) according to claim 1 or 2,
wherein the output region (36) comprises at least one elongate stroking/sweeping surface (40a, 40b) configured to stroke construction material output from the container (32), and
wherein the at least one stroking/sweeping surface (40a, 40b) is wiped by means of the cleaning web (52) for cleaning the same by the relative movement between the output region (36) and the cleaning web (52).

4. The 3D printer (10) according to claim 3, wherein in a plan view of the coater (30) from above, a longitudinal axis (L1a, L1b; x) of the at least one stroking/sweeping surface (40a, 40b) is disposed at an angle to a longitudinal axis (L2; y) of the cleaning web (52) when the coater (30) is in a cleaning position in which it is disposed above the coater cleaning device (50).

5. The 3D printer (10) according to claim 3 or 4, wherein the cleaning web (52) approaches the at least one stroking/sweeping surface (40a, 40b) from below in a cross-sectional view of the coater (30) in such a way that the longitudinal axis (L2) of the cleaning web (52) forms an acute (entrance) angle with the at least one stroking/sweeping surface (40a, 40b) when the coater (30) is in a cleaning position.

6. The 3D printer (10) according to any one of claims 3 to 5, wherein the cleaning web (52) has such an extension in the width direction (B) that in a plan view of the coater (30) from above and/or in a side view thereof the two longitudinal ends (40aa, 40ab, 40ba, 40bb) of the at least one stroking/sweeping surface (40a, 40b) do not extend beyond the cleaning web (52) when the coater (30) is in a cleaning position.

7. The 3D printer (10) according to any one of the preceding claims, wherein the cleaning web (52) is made of an absorbent material configured to absorb a liquid cleaning agent, for example of an absorbent textile such as an absorbent fabric or an absorbent nonwoven.

8. The 3D printer (10) according to any one of the preceding claims, wherein the coater cleaning device (50) comprises a pressing device (70) adapted to press a portion of the cleaning web (52) against the output region (36) when the coater (30) is in a cleaning position.

9. The 3D printer (10) according to claim 8, wherein the pressing device (70) comprises a support structure (72) over which the cleaning web (52) extends, the support structure (72) being optionally height-adjustable, wherein, for example, in a cleaning position of the coater, the support structure, the cleaning web and the coater are cut by a common imaginary vertical line.

10. The 3D printer (10) according to claim 9, wherein the support structure (72) comprises a sliding element (74) on which the cleaning web (52) is supported, and wherein the sliding element (74) is made of an elastic material and/or wherein a spring force is applied to the sliding element (74), which spring force presses the sliding element (74) against the cleaning web (52) and, as a result, the cleaning web (52) against the output region (36) when the coater (30) is in a cleaning position.

11. The 3D printer (10) according to any one of the preceding claims, wherein the coater cleaning device (50) comprises a cleaning agent supply device (90) configured to supply a cleaning agent to the cleaning web (52), wherein, for example, the cleaning agent supply device (90) is configured to moisten and/or infiltrate a portion of the cleaning web (52) with cleaning agent, which portion, as viewed in the longitudinal direction of the web, is arranged in front of or in a contact region (110) at which the output region (36) and the cleaning web (52) contact one another for wiping off the output region (36) by means of the cleaning web (52).

12. The 3D printer (10) according to any one of the preceding claims, wherein the coater cleaning device (50) comprises a rotatable roll-up element (130), e.g. a rotatable roll-up roller, onto which the cleaning web (52) (e.g. a dirty/consumed portion thereof) can be rolled/wound up, wherein the roll-up element (130) is optionally replaceable for removing the dirty cleaning web (52) from the coater cleaning device (50) and/or optionally is a driven roll-up element.

13. The 3D printer (10) according to any one of the preceding claims, wherein the coater cleaning device (50) comprises a rotatable roll-off element (132), e.g. a rotatable roll-off roller, from which the cleaning web (52) (e.g. a fresh portion thereof) can be rolled/wound off, wherein the roll-off element (132) is optionally exchangeable for refilling another roll-off element, on which a fresh cleaning web (52) is rolled up, and/or optionally is a driven roll-off element.

14. The 3D printer (10) according to any one of claims 7 to 13, wherein the coater cleaning device (50) comprises a sensor (150) for determining the amount of cleaning agent received by the cleaning web (52) in a portion thereof.

15. The 3D printer (10) according to any one of the preceding claims, wherein the coater cleaning device (50) comprises a controller (170) configured to control, for example variably adjust, for example depending on a degree of contamination of the output region (36) and/or a period of time elapsed since the last cleaning and/or a construction material used in 3D printing and/or a binder component used in 3D printing and/or a quantity of cleaning agent absorbed by the cleaning web (52),
the relative movement between the output region (36) and the cleaning web (52) for wiping off the output region (36) by means of the cleaning web (52), “movement pattern”, and/or
the quantity and/or type of cleaning agent supplied to the cleaning web by the cleaning agent supply device (90) of claim 11, and/or
a height adjustment of the support structure of claim 9 and/or the spring force of claim 10 and/or a pressing force of the pressing device of claim 8, and/or
a drive of the roll-up element (130) and/or a drive of the roll-off element (132).

16. The 3D printer (10) according to any one of the preceding claims, wherein the coater cleaning device (50) comprises a driving device configured to move the cleaning web in the longitudinal direction thereof, for example past the output region and/or for example for providing a fresh and/or moistened and/or infiltrated cleaning web portion for wiping the output region (36) by means of the cleaning web (52).

17. A coater (30) in combination with a coater cleaning device (50), wherein
the coater cleaning device (50) comprises a cleaning web (52), and
the coater cleaning device (50) and the coater (30) are configured to perform a relative movement between the coater (30) and the cleaning web (52) in a state in which the coater (30) is contacted by a portion of the cleaning web (52), for wiping the coater (30) by means of the cleaning web (52).

18. A method for cleaning a coater (30) of a 3D printer (10) by means of a coater cleaning device (50), wherein the coater cleaning device (50) has a cleaning web (52) which is for example made of an absorbent material and/or is configured to be finite and/or is formed as a disposable web and/or is configured to be exchangeable, comprising:
contacting the coater (30) with the cleaning web (52); and
performing a relative movement between the coater (30) and the cleaning web (52) for wiping the coater (30) by means of the cleaning web (52), for example in a moistened state of the cleaning web and/or by moving the coater, for example in a direction transverse to the longitudinal direction thereof.
